(19) United States
(12) Patent Application Publication
(10) Pub. No.: US 2019/0070841 A1
(43) Pub. Date: Mar. 7, 2019

(54) METHOD FOR MANUFACTURING OPTICAL DISPLAY DEVICE

(71) Applicant: NITTO DENKO CORPORATION, Ibaraki-shi, Osaka (JP)

(72) Inventors: Teruaki OSAWA, Ibaraki-shi, Osaka (JP); Kazuo KITADA, Ibaraki-shi, Osaka (JP); Takuya NAKAZONO, Ibaraki-shi, Osaka (JP); Daigo SUZUKI, Ibaraki-shi, Osaka (JP); Hiroyuki ABE, Ibaraki-shi, Osaka (JP); Masatake USUI, Ibaraki-shi, Osaka (JP)

(21) Appl. No.: 16/083,791

(22) PCT Filed: Mar. 16, 2017
(86) PCT No.: PCT/JP2017/010610

§ 371 Date: Sep. 10, 2018

(30) Foreign Application Priority Data
Mar. 16, 2016 (JP) 2016-051758

(51) Int. Cl. B32B 37/12; B32B 7/12; B32B 38/10; B32B 41/00

(52) U.S. Cl. CPC B32B 37/12; B32B 7/12; B32B 2457/20; B32B 41/00; B32B 2041/04; B32B 38/10

(57) ABSTRACT

A method for manufacturing an optical display device from a web of optical film laminate including a carrier film, a pressure-sensitive adhesive layer formed on one of opposite surfaces of the carrier film, and a plurality of sheets of optical functional film continuously supported on the carrier film via the pressure-sensitive adhesive layer, comprises folding the other of opposite surfaces of the carrier film inside via a tip end of a releasing body to wind the carrier film, peeling the sheet of optical functional film to a head-out state while exposing the pressure-sensitive adhesive layer, stopping winding of the carrier film, detecting a front end of the peeled sheet of optical functional film in the head-out state, and rewinding the carrier film integrally with the sheet of optical functional film in the head-out state to mend a deformation of a pressure-sensitive adhesive, at the tip end of the releasing body.

### CROSS REFERENCE TO RELATED APPLICATION

This application claims the priority of Japanese Patent Application No. 2016-051758, filed on Mar. 16, 2016, in the JPO (Japanese Patent Office). Further, this application is the National Phase application of International Application No. PCT/JP2017/010610, filed on Mar. 16, 2017, which designates the United States and was published in Japan. Both of the priority documents are hereby incorporated by reference in their entireties.

### TECHNICAL FIELD

The present invention relates to a method for manufacturing an optical display device.

More particularly, the present invention relates to a method for manufacturing an optical display device from a web of optical film laminate including a carrier film, a pressure-sensitive adhesive layer formed on one of opposite surfaces of the carrier film, and a plurality of sheets of optical functional film continuously supported on the carrier film via the pressure-sensitive adhesive layer, by folding the other of opposite surfaces of the carrier film inside at a tip end of a releasing body having the tip end arranged at a position facing the laminating position, to wind the carrier film, and peeling the sheet of optical functional film together with the pressure-sensitive adhesive layer to a head-out state from the carrier film, detecting a front end of the sheet of optical functional film in the head-out state at a detecting position, after the front end is detected, winding and hooking the carrier film around the releasing body to rewind the carrier film integrally with the sheet of optical functional film in the head-out state to mend a deformation of a pressure-sensitive adhesive at the tip end of the releasing body, generated at the peeling position of the pressure-sensitive adhesive layer peeled to the head-out state and exposed, after the pressure-sensitive adhesive layer is mended, winding the carrier film again, peeling the sheet of optical functional film with the mended pressure-sensitive adhesive layer to feed the front end to the laminating position, and laminating the sheet of optical functional film with a corresponding one of the panel members conveyed separately via the pressure-sensitive adhesive layer at the laminating position by a laminating unit.

### BACKGROUND ART

In recent years, in a manufacturing scene of optical display devices, a manufacturing apparatus and a method of Roll-to-Panel (RTP) are employed. As described in Patent Literature 1, in the RTP method, generally, an optical display device is manufactured as follows. First, a web of optical film laminate having a predetermined width is fed from a roll arranged on the manufacturing apparatus. The web of optical film laminate is configured as including a web of carrier film, a pressure-sensitive adhesive layer formed on one of opposite surfaces of the carrier film, and an optical film supported on the carrier film via the pressure-sensitive adhesive layer. The optical film may be a single-layered or multi-layered film. On the web of optical film laminate fed from the roll, slit lines are continuously formed in a width-wise direction to form sheets of optical functional film between adjacent slit lines.

Among the sheets of optical functional film continuously supported on the carrier film, generally, normal sheets which do not have defect or defects are peeled with the pressure-sensitive adhesive layer from the carrier film, specifically, by a peeling means comprised of, specifically, a substantially wedge-shaped releasing body having a tip, arranged near a laminating position, and fed to the laminating position. Each of the sheets of optical functional film which has reached to the laminating position is laminated with a face to be laminated of a corresponding panel member separately conveyed to the laminating position, specifically, by a laminating unit having a pair of upper and lower lamination rollers.

At the peeling means having a tip end facing the laminating position, a carrier film side of the optical film laminate is wound and hooked around the tip end of the substantially wedge-shaped releasing body. The sheet of optical functional film is peeled in the head-out state together with the pressure-sensitive adhesive layer from the carrier film as the carrier film wound and hooked around the releasing body is conveyed to a direction substantially opposite to a conveying direction of the sheet of optical functional film being conveyed toward the laminating position. In the present specification, a position of the apparatus where the sheet of optical functional film is peeled from the carrier film is referred as a “peeling position,” and the peeling position corresponds to the position of the tip end of the releasing body having the tip end.

In such RTP system, the sheet of optical functional film of the carrier film may be fed to the laminating position with the panel member, with its posture deviated from the ideal one. In this case, as described in Patent Literature 2, it is necessary to laminate the panel member with the sheet of optical functional film after correcting (also referred as “aligning”) the posture of the panel member depending on a deviation condition of the sheet of optical functional film. In order to determine the posture of the sheet of optical functional film required for this correction, a front end of the sheet of optical functional film is detected by taking an image thereof using an imaging means such as an optical camera, for example. In detecting the front end, as shown in FIG. 5 of Patent Literature 2, it is preferable to detect it when a front part, in the conveying direction, of the sheet of optical functional film is peeled from the carrier film and the front end is between the peeling position and the laminating position. In the present specification, the sheet of optical functional film peeled from the carrier film when the front end is detected is referred as “a sheet of optical functional film peeled to a head-out state” or “a sheet of optical functional film in a head-out state”.

Also, in such RTP system, as described in Patent Literature 3, it is necessary to add a function which allows for backwardly feeding the carrier film with a tensile force controlled, that is, a function to allow for a backward feeding, and forwardly feed the sheet of optical functional film including the pressure-sensitive adhesive layer folded over at the tip end of the releasing body having the tip end arranged at the position facing the laminating position and peeled from the carrier film, or backwardly feed the peeled sheet of optical functional film including the pressure-sensitive adhesive layer, for precise alignment.

At such time, as described in Patent Literature 4, the front end of the optical film may be backwardly fed from where the front end of the sheet of optical function film is forwardly fed as exceeding a predetermined position back to the predetermined position for positioning thereof. In addition, when positioning the film in the predetermined position, as described in Patent Literature 5, tensile forces before and after the carrier film is folded over may be adjusted to be equal so that no error is generated in length of the sheet of optical functional film in the head-out state.

### CITATION LIST

Patent Literature 1: Japanese Patent Number 4377964

Patent Literature 2: Japanese Patent Number 5458212

Patent Literature 3: Japanese Patent Number 5427929

Patent Literature 4: Laid-Open Japanese Patent Application Publication: JP2014-066909A

Patent Literature 5: Japanese Patent Number 5452761

### SUMMARY OF INVENTION

### Technical Problem

FIG. 1 is a schematic diagram illustrating a typical RTP manufacturing apparatus 10. When described using FIG. 1, in the manufacturing apparatus 10 of a configuration where a front end 31 of a sheet of optical functional film 3 is detected when the front end 31 is at a detecting position 200 between a peeling position 300 and a laminating position 100, when the sheet of optical functional film 3 is peeled to the head-out state and the front end 31 reaches a detecting position 200, winding of a carrier film 2 is stopped. At this point, a pressure-sensitive adhesive layer 4 is peeled from the carrier film 2 being exposed from the front end 31 with the sheet of optical functional film 3 in the head-out state, and from such portion to a rear end 32, it is still laminated to the carrier film 2.

When the conveying of the sheet of optical functional film 3 is stopped by stopping the winding of the carrier film 2, a linear deformation 40 of a pressure-sensitive adhesive 41 is generated on an exposed surface of the pressure-sensitive adhesive layer 4 being peeled, at a part of the pressure-sensitive adhesive layer 4 corresponding to the peeling position 300 when stopped. The deformation 40 of the pressure-sensitive adhesive 41 is formed, as shown in FIG. 2 (a), along the front end 31, extending in a width direction, at a front portion in a conveying direction of the sheet of optical functional film 3, specifically, at the peeling position 300 which is a contact point of a tip end 61 of a releasing body 60 and the sheet of optical functional film 3 being peeled. Also, FIG. 2 (b) shows a result of a part of the deformation 40 of the pressure-sensitive adhesive 41 generated on the pressure-sensitive adhesive layer 4 observed by a microscope. If the sheet of optical functional film 3 having the pressure-sensitive adhesive layer 4 with such deformation 40 generated thereon is laminated with a corresponding one of panel members 5, the deformation 40 of the sheet of optical functional film 3 by the deformed pressure-sensitive adhesive layer 4 and/or entrapment of bubbles between the panel member 5 and the pressure sensitive adhesive layer 4 may be generated, and these may be a cause of image defect or defects of an optical display device 6.

Each of optical film laminates 1 respectively shown in FIG. 3 (a) and FIG. 3 (b) is generally a laminate in which the carrier film 2 is laminated to one of opposite surfaces of an optical film portion 3′ via the pressure-sensitive adhesive layer 4. A surface protection film is laminated to the other of opposite surfaces of the optical film portion 3′ via another pressure-sensitive adhesive layer. This portion is for protecting the optical film portion 3′ in a process of manufacturing the optical display device 6, and during the process of manufacturing the optical display device 6, it is a film laminated to the sheet of optical functional film 3. The sheet of optical functional film 3 in the present specification is made by forming slit lines on the optical film portion 3′ including a pressure-sensitive adhesive layer 4′ to form a size of the panel member 5 including the pressure-sensitive adhesive layer 4.

Therefore, a thickness of the pressure-sensitive adhesive layer 4 of the sheet of optical functional film 3 to be laminated to the optical display device 6 is about 20 μm to 30 μm. On the other hand, a thickness of the sheet of optical functional film 3 of the optical film laminate 1 having a typical thickness is 255 μm as shown in FIG. 3 (a), and when the thickness of the pressure-sensitive adhesive layer 4 is added, the thickness becomes about 280 μm. The thickness of the pressure-sensitive adhesive layer 4 is about one-tenth of it. Such thickness of the pressure-sensitive adhesive layer may not be recognized as the deformation 40 to the extent of becoming defect or defects on an image of the optical display device 6, and the defect or defects are not so much as being a problem.

However, as the optical functional film laminate 1 gets thinner, and as shown in FIG. 3 (b), when the optical film having the sheet of optical functional film 3 which thickness is 135 μm to 175 μm appears, the thickness of the pressure sensitive adhesive layer 4 becomes ⅕ to 1/7 thereof. Actually, since the surface protection film and a second pressure-sensitive adhesive layer are eventually peeled off integrally to be disposed, the thickness of the sheet of optical functional film is 45 μm to 85 μm, the thickness of a first pressure-sensitive adhesive layer thereto is 25 μm, and the deformation 40 of the pressure-sensitive adhesive 41 generated thereon, formed linearly on the exposed surface of the pressure-sensitive adhesive layer 4 is unneglectable as defect or defects on the image of the optical display device 6.

The problem to be solved by the present invention is to provide a method for manufacturing the optical display device 6 which solves this problem by preliminarily mending the deformation 40 of the pressure-sensitive adhesive 41 generated on the pressure-sensitive layer 4 before laminating the sheet of optical functional film 3 with a corresponding one of the panel members 5.

### Solution to Problem

In order to solve the above problem, the present invention provides, in one aspect thereof, a method for manufacturing an optical display device 6 from a web of optical film laminate 1 including a carrier film 2, a pressure-sensitive adhesive layer 4 formed on one of opposite surfaces of the carrier film 2, and a plurality of sheets of optical functional film 3 continuously supported on the carrier film 2 via the pressure-sensitive adhesive layer 4, by folding the other of opposite surfaces of the carrier film 2 inside via a tip end 61 of a releasing body 60 having the tip end 61 to wind the carrier film to expose the pressure-sensitive adhesive layer 4 and to peel the sheet of optical functional film 3 to a head-out state, stopping winding of the carrier film 2 to detect a front end 31 of the peeled sheet of optical functional film 3 in the head-out state, after the front end 31 is detected, winding and hooking the carrier film 2 around the releasing body 60 to rewind the carrier film 2 integrally with the sheet of optical functional film 3 in the head-out state to mend a deformation 40 of a pressure-sensitive adhesive 41 at the tip end 61 of the releasing body 60, generated at a peeling position 300 of the pressure-sensitive adhesive layer 4 peeled to the head-out state and exposed, after the pressure-sensitive adhesive layer 4 is mended, winding the carrier film 2 again, peeling the sheet of optical functional film 3 with the mended pressure-sensitive adhesive layer 4 to feed the front end 31 to a laminating position 100, and laminating the sheet of optical functional film 3 with the corresponding one of panel members 5 conveyed separately via the pressure-sensitive adhesive layer 4 at the laminating position 100 by a laminating unit 50.

A manufacturing apparatus providing such method is, as shown in FIG. 1, a manufacturing apparatus 10 for manufacturing the optical display device 6 by peeling the pressure-sensitive adhesive layer 4 of a web of optical film laminate 1 including the carrier film 2, the pressure-sensitive adhesive layer 4 formed on one of opposite surfaces of the carrier film 2, and a plurality of sheets of optical functional film 3 continuously supported on the carrier film 2 via the pressure-sensitive adhesive layer 4 together with the sheets of optical functional film 3 from the carrier film 2, and laminating the peeled sheet of optical functional film 3 with the corresponding one of panel members 5 at the laminating position 100.

The manufacturing apparatus 10 includes the laminating unit 50 for laminating the sheet of optical functional film 3 with one of opposite surfaces of the panel member 5 by the pressure-sensitive adhesive layer 4 at the laminating position 100; the substantially wedge-shaped releasing body 60 having the tip 61, arranged at the peeling position 300 facing the laminating position 100, which operates to fold the other of opposite surfaces of the carrier film 2 inside to wind the carrier film, peel the sheet of optical functional film 3 with the pressure-sensitive adhesive layer 4 from the carrier film 2 and feed the front end 31 of the peeled sheet of optical functional film 3 with the exposed pressure-sensitive adhesive layer 4 in a direction of the laminating position 100; a detecting unit 70 for stopping winding of the carrier film 2 when the front end 31 of the peeled sheet of optical functional film 3 reaches the detecting position 200 between the tip end 61 and the laminating position 100 where the front end 31 is detected, to read the front end 31; a carrier film conveying unit 80 which operates to peel the sheet of optical functional film 3 with the pressure-sensitive adhesive layer 4 from the carrier film 2 by winding or rewinding, without slacking, the carrier film 2 which the other of opposite surfaces is folded inside at the tip end 61 and wound and hooked around the releasing body 60, and to forwardly feed the front end 31 to the laminating position 100, or to backwardly feed the sheet of optical functional film 3 with the pressure-sensitive adhesive layer 4 in the head-out state to a backwardly fed position 400; and a panel member conveying unit 90 for conveying the panel member 5 to be laminated with the sheet of optical functional film 3 from a waiting position 500 to the laminating position 100.

The manufacturing apparatus 10 associates each of the laminating unit 50, the detecting unit 70, the carrier film conveying unit 80, and the panel member conveying unit 90 by the controlling unit 20, winds the carrier film 2 via the tip end 61 of the releasing body 60 having the tip end 61, peels the sheet of optical functional film 3 with the exposed pressure-sensitive adhesive layer 4 from the carrier film 2, after the front end 31 is detected by the detecting unit 70 by stopping winding of the carrier film 2, once rewinds the carrier film 2, and backwardly feeds the peeled sheet of optical functional film 3 to mend the deformation 40 of the pressure-sensitive adhesive 41, at the tip end 61, generated on the exposed pressure-sensitive adhesive layer 4 and the peeling position 300, and then, starts winding of the carrier film 2 again. The manufacturing apparatus 10 further operates to feed the sheet of optical functional film 3 with the mended pressure-sensitive adhesive layer 4 to the laminating position 100, and laminate it with a corresponding one of the panel members 5 at the laminating position 100 to manufacture the optical display device 6.

An embodiment of the present invention is as in the following.

The aspect of the present invention is a method for manufacturing the optical display device 6 from the web of optical film laminate 1 including the carrier film 2, the pressure-sensitive adhesive layer 4 formed on one of opposite surfaces of the carrier film 2, and a plurality of sheets of optical functional film 3 continuously supported on the carrier film 2 via the pressure-sensitive adhesive layer 4, by peeling the sheet of optical functional film 3 together with the pressure-sensitive adhesive layer 4, and laminating the peeled sheet of optical functional film 3 with a corresponding one of panel members 5 at the laminating position 100, the method comprising steps of:

folding the other of opposite surfaces of the carrier film 2 inside at the tip end 61 of the releasing body 60 having the tip end 61 arranged at a position facing the laminating position 100, to wind the carrier film 2, and peeling the sheet of optical functional film 3 together with the pressure-sensitive adhesive layer 4 to the head-out state from the carrier film 2,

when the front end 31 of the sheet of optical functional film 3 in the head-out state reaches the detecting position 200 between the peeling position 300, where the sheet of optical functional film 3 is peeled from the carrier film 2 at the tip end 61, and the laminating position, winding of the carrier film 2 is stopped for detecting the front end 31,

after the front end 31 is detected, winding and hooking the carrier film 2 around the releasing body 60 to be rewound to backwardly feed the sheet of optical functional film 3 in the head-out state and the pressure-sensitive adhesive layer 4 together to mend the deformation 40 of the pressure-sensitive adhesive 41 of the pressure-sensitive adhesive layer 4 at the tip end 61 of the releasing body 60, generated at the peeling position 300 of the pressure-sensitive adhesive layer 4 peeled to the head-out state and exposed,

conveying the panel member 5 to be laminated with the sheet of optical functional film 3 from the waiting position 500 to the laminating position 100,

after the pressure-sensitive adhesive layer 4 is mended, winding the carrier film 2 again, peeling the sheet of optical functional film 3 with the mended pressure-sensitive adhesive layer 4 from the carrier film 2 to feed the front end 31 to the laminating position 100, and

when the front end 31 reached the laminating position 100, laminating the sheet of optical functional film 3 with a corresponding one of the panel members 5 via the pressure-sensitive adhesive layer 4 by a laminating unit 50.

In the embodiment of the present invention, when the carrier film 2 is wound and hooked around the releasing body 60 to backwardly feed the sheet of optical functional film 3 in the head-out state with the pressure-sensitive adhesive layer 4, the sheet of optical functional film 3 may be backwardly fed until the front end 31 reaches the backwardly fed position 400 upstream of the tip end 61 of the releasing body 60 from the detecting position 200. In addition, in winding and hooking the carrier film 2 around the releasing body 60 for rewinding, it may be rewound at a steady tension to laminate the sheet of optical functional film 3 in the head-out state again on the rewound carrier film 2 with the mended pressure-sensitive adhesive layer 4.

In the embodiment of the present invention, also, the detecting position 200 is preferably made as a position 10 mm or more to 30 mm or less from the tip end 61 of the releasing body 60 facing the laminating position 100, and which does not reach the laminating position 100. Further, a distance which the carrier film 2 is rewound after the front end 31 is detected is preferably a distance between the position of the tip end 61 of the releasing body 60 and the detecting position 200 or longer.

In the embodiment of the present invention, it is preferable that a thickness of the sheet of optical functional film 3 is in a range of 45 μm to 85 μm, and a thickness of the pressure-sensitive adhesive layer is 20 μm to 30 μm.

### BRIEF DESCRIPTION OF DRAWINGS

FIG. 1 is an overview of a manufacturing apparatus for manufacturing an optical display device.

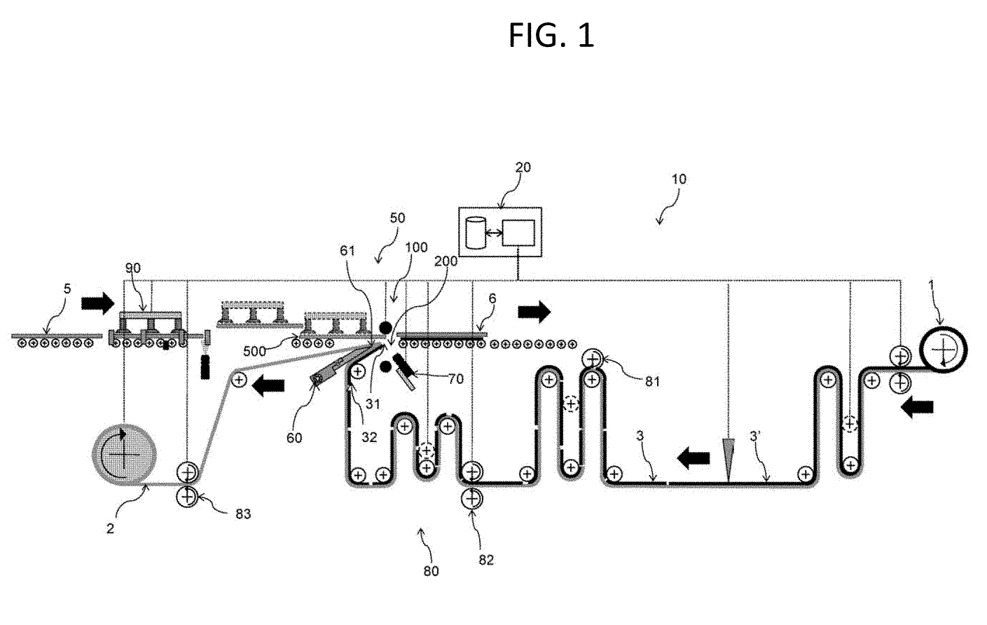

FIG. 2 (a) and FIG. 2 (b) show a deformation of a pressure-sensitive adhesive of a pressure-sensitive adhesive layer.

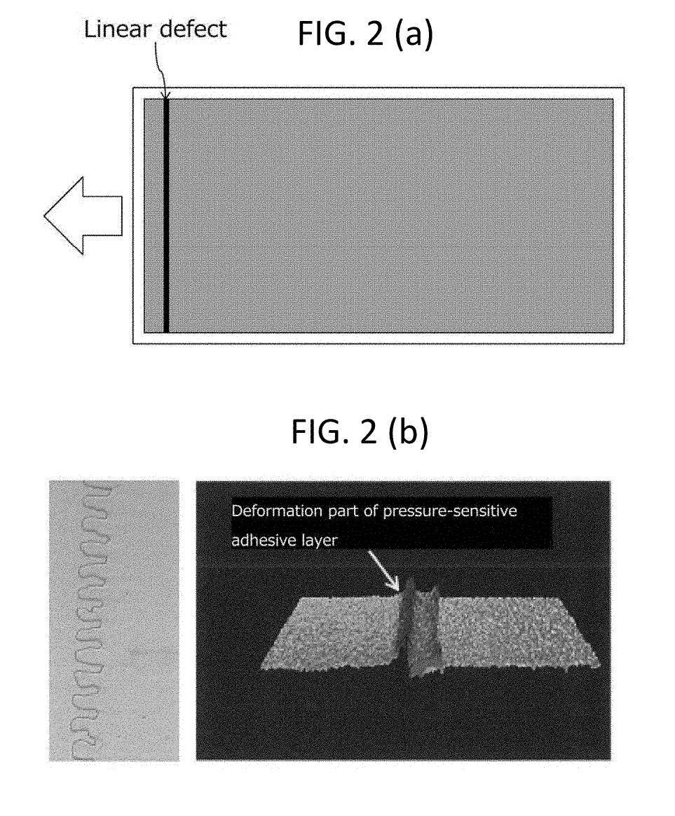

FIG. 3 is a structure of an optical film laminate.

FIG. 4 is an operation flow.

FIG. 5 (a), FIG. 5 (b) and FIG. 5 (c) show configurations and a Table of results of Examples and Comparative Examples.

FIG. 6 (a), FIG. 6 (b) and FIG. 6 (c) show cause analysis diagrams of the deformation of the pressure-sensitive adhesive layer and experimental results.

### DESCRIPTION OF EMBODIMENTS

### [Cause of Generation of Deformation by Pressure-Sensitive Adhesive of Pressure-Sensitive Adhesive Layer]

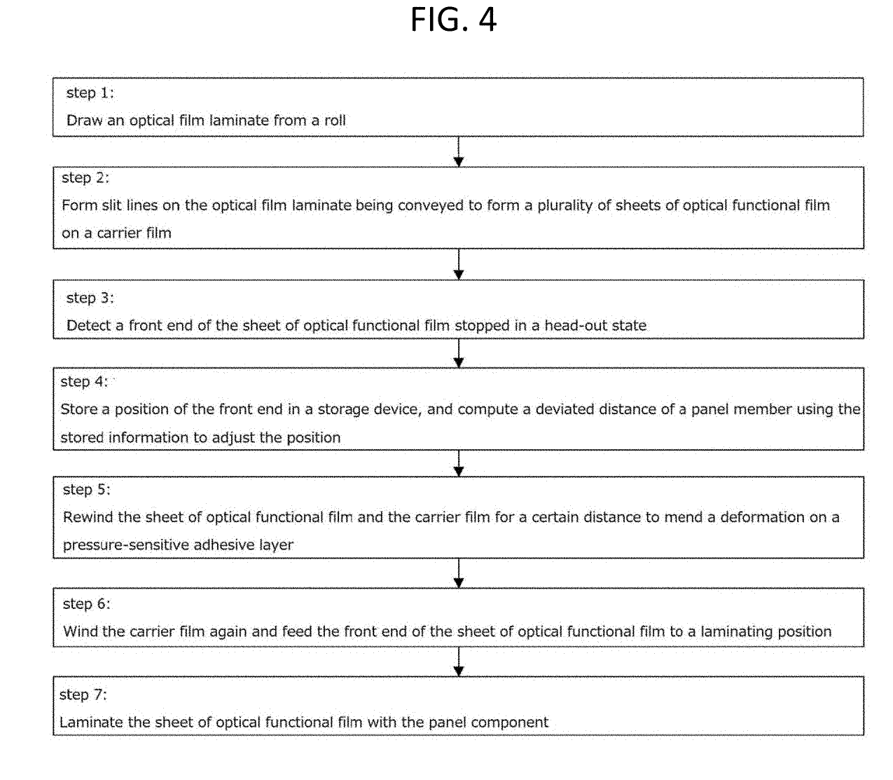

As apparent from an operation flow of FIG. 4, from Step 1 in which the optical film laminate 1 is drawn from a roll arranged in the manufacturing apparatus 10, Step 2 succeeds in which slit lines are formed in a width direction to form a size of the panel member 5 on an optical film part 3′ of the optical film laminate 1 being conveyed so that a plurality of sheets of optical functional film 3 on the carrier film 2 are formed, and the carrier film 2 is wound at the tip end 61 of the releasing body 60, and winding of the carrier film 2 is stopped where the sheet of optical functional film 3 is peeled from the carrier film 2 in a head-out state. Such stopping of winding leads to Step 3 in which the front end 31 of the sheet of optical functional film 3 is detected in a head-out state. Detection of the front end 31 is a step of storing a position of the front end in a storage device (not shown), and computing a deviated distance from the panel member using the stored information to adjust a deviated position of the panel member. The preceding steps are steps for manufacturing the optical display device 6 by the RTP manufacturing apparatus 10 also described in Patent Literature 5.

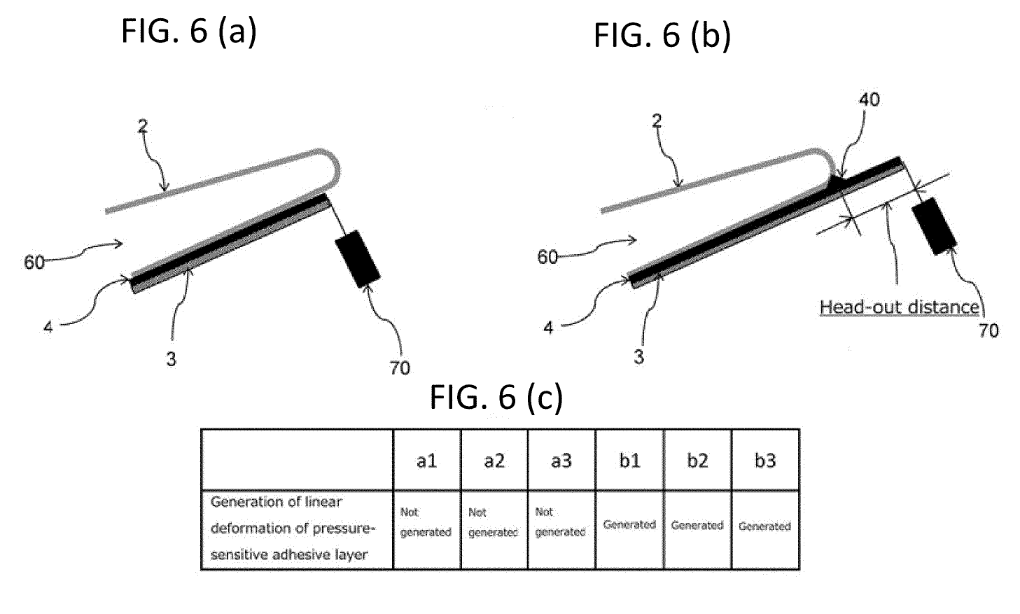

FIG. 6 (a) and FIG. 6(b) show cause analysis diagrams of the deformation of the pressure-sensitive adhesive layer. The cause of the deformation of the pressure-sensitive adhesive layer is apparent from schematic diagrams in FIG. 6 (a) and FIG. 6 (b). For the sheet of optical functional film shown in FIG. (a) which is without the head-out state for alignment, as shown in Table in FIG. 6 (c), the linear deformation is not generated on the pressure-sensitive adhesive layer. However, for the sheet of optical functional film in FIG. 6 (b) in the head-out state for alignment, as shown in Table in FIG. 6 (c), a head-out distance and a distance between a position where the linear deformation generated and the front end of the film matches. The peeling position for the peeling at the tip end 61 of the releasing body 60 is the position where the linear deformation is generated.

Step 5 of FIG. 4 is a step of mending the generated linear deformation. After the front end 31 is detected with the sheet of optical functional film 3 in the head-out state of FIG. 6 (b), the sheet of optical functional film 3 in the head-out state and the carrier film 2 are wound and hooked around the releasing body 60 by second feed rollers 82 of the film conveying device 80 so that a certain distance is rewound. Such back feeding pushes the bulged deformation of the pressure-sensitive adhesive generated at the peeling position 300 back at the tip end of the releasing body 60 to be mended. Needless to say, a head-out time for detection is very short in relation to a tact time, and the back feeding in a fairly early timing improves mending accuracy. Next, in Step 6, the film conveying unit 80 is actuated again to wind the carrier film 2 and feed the front end 31 of the sheet of optical functional film 3 to the laminating position 100, and in Step 7, it is laminated with the separately conveyed panel member 5 to complete the optical display device 6.

### Examples and Comparative Examples

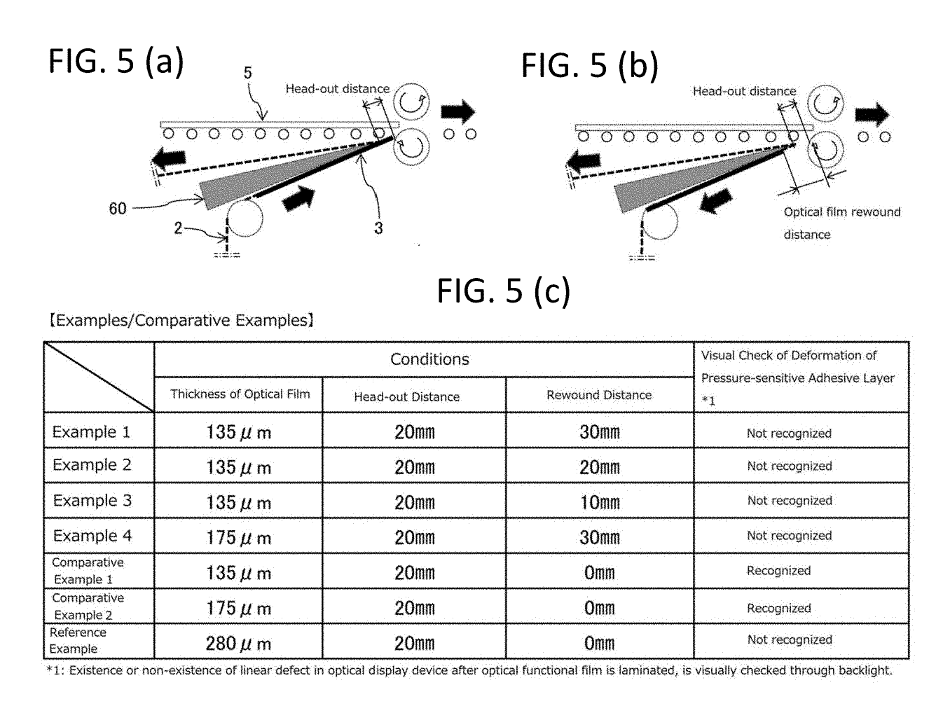

FIG. 5 (a) shows the sheet of optical functional film in the head-out state in which the carrier film 2 is being wound and peeled, and FIG. 5 (b) shows the sheet of optical functional film being rewound integrally with the carrier film 2 to the backwardly fed position 400. FIG. 5 (c) shows Examples and Comparative Examples visually checked as such.

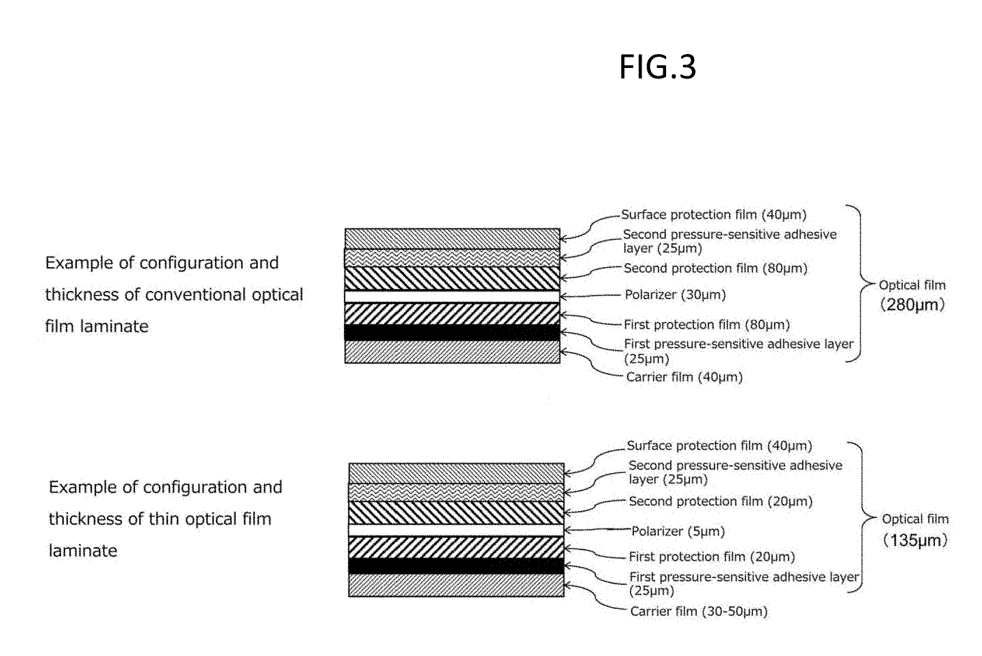

Each of Examples 1 to 3 is of the sheet of optical functional film shown in FIG. 3 (b) having the thinnest thickness, and Example 4 is based on the thickness of the sheet of optical functional film also shown in FIG. 3 (b). All of the films are visually checked through a backlight as to whether the linear deformation 40 is generated in the optical display device 6, and it was not recognized.

Comparative Example 1 is of a thickness of the optical functional film used in Examples 1 to 3, and when the optical display device 6 is visually checked, which is manufactured by feeding the sheet of optical functional film peeled integrally with the carrier film 2 to the head-out state to the laminating position 100 without rewinding, the linear deformation 40 was recognized. Comparative Example 2 is of the sheet of optical functional film 3 having a thickness the same as Example 4, and when an optical display device fed to the laminating position 100 also without rewinding is visually checked, the linear deformation 40 was also recognized.

Reference Example 4 is a result of a visual check which is the same as Comparative Examples using the optical film of FIG. 3 (a) having a conventional thickness. Here, a thickness of the sheet of optical functional film is 280 μm, and a winding process therefor does not exist. The linear deformation 40 was visually checked, but it was not recognized in terms of results.

### REFERENCE SIGNS LIST

1: Optical film laminate
2: Carrier film
3: Sheet of optical functional film
3′: Part of optical film before forming slit lines
31: Front end of sheet of optical functional film
32: Rear end of sheet of optical functional film
4: Pressure-sensitive adhesive layer
41: Pressure-sensitive adhesive
40: Deformation by pressure-sensitive adhesive of pressure-sensitive adhesive layer
5: Panel member
6: Optical display device
10: RTP manufacturing apparatus
20: Controlling unit
50: Laminating unit
60: Releasing body
61: Tip end of releasing body
70: Detecting unit
80: Film conveying unit
81: First feed rollers
82: Second feed rollers
83: Third feed rollers
90: Panel member conveying unit
100: Laminating position
200: Detecting position
300: Peeling position
400: Backwardly fed position
500: Waiting position of panel member

1. A method for manufacturing an optical display device from a web of optical film laminate including a carrier film, a pressure-sensitive adhesive layer formed on one of opposite surfaces of the carrier film, and a plurality of sheets of optical functional film continuously supported on the carrier film via the pressure-sensitive adhesive layer, by peeling the sheet of optical functional film together with the pressure-sensitive adhesive layer from the carrier film of the web of optical film laminate, and laminating the peeled sheet of optical functional film with a corresponding one of panel members at a laminating position, the method comprising steps of:
folding the other of opposite surfaces of the carrier film inside at a tip end of a releasing body having the tip end arranged at a position facing the laminating position, to wind the carrier film, and peeling the sheet of optical functional film together with the pressure-sensitive adhesive layer to a head-out state from the carrier film,
when a front end of the sheet of optical functional film in the head-out state reaches a detecting position between a peeling position, where the sheet of optical functional film is peeled from the carrier film at the tip end, and the laminating position, winding of the carrier film is stopped for detecting the front end,
after the front end is detected, winding and hooking the carrier film around the releasing body to be rewound to backwardly feed the sheet of optical functional film in the head-out state with the pressure-sensitive adhesive layer to mend a deformation of a pressure-sensitive adhesive of the pressure-sensitive adhesive layer, at the tip end of the releasing body, generated at the peeling position of the pressure-sensitive adhesive layer peeled to the head-out state and exposed,
conveying a panel member to be laminated with the sheet of optical functional film from a waiting position to the laminating position,
after the pressure-sensitive adhesive layer is mended, winding the carrier film again, peeling the sheet of optical functional film with the mended pressure-sensitive adhesive layer from the carrier film to feed the front end to the laminating position, and
when the front end reached the laminating position, laminating the sheet of optical functional film with corresponding one of the panel members via the pressure-sensitive adhesive layer by a laminating unit.

2. The method according to claim 1, wherein winding and hooking the carrier film around the releasing body to backwardly feed the sheet of optical functional film in the head-out state with the pressure-sensitive adhesive layer includes backwardly feeding the sheet of optical functional film until the front end reaches a backwardly fed position upstream of the tip end of the releasing body from the detecting position.

3. The method according to claim 1, wherein winding and hooking the carrier film around the releasing body for rewinding includes rewinding the carrier film at a steady tension to laminate the sheet of optical functional film in the head-out state again on the rewound carrier film with the mended pressure-sensitive adhesive layer.

4. The method according to claim 1, wherein the detecting position is configured as a position which is 10 mm or more to 30 mm or less from the tip end facing the laminating position, and which does not reach the laminating position.

5. The method according to claim 1, wherein a distance which the carrier film is rewound after the front end is detected is a distance between the peeling position and the detecting position or longer.

6. The method according to claim 1, wherein a thickness of the sheet of optical functional film is in a range of 45 μm to 85 μm, and a thickness of the pressure-sensitive adhesive layer is 20 μm to 30 μm.
